(19) United States
(12) Patent Application Publication
(10) Pub. No.: US 2011/0120260 A1
(43) Pub. Date: May 26, 2011

(54) Mobility pedal structure for electric scooter

(76) Inventor: Jhen-Ci Siao, Chia Yi City (TW)

(21) Appl. No.: 12/591,522

(22) Filed: Nov. 23, 2009

(51) Int. Cl. G05G 1/44

(52) U.S. Cl. 74/560

(57) ABSTRACT

This invention relates to a mobility pedal structure for electric scooter in which a spindle is rotationally supported on two side plates of a base. A speed control device is connected to one side of the spindle and a recovery spring element is inserted onto outside of the spindle. A connection block is fixed on the spindle, on which a connection rod having an advance control portion and a retreat control portion is coupled. Then, the base is disposed at a position where user's foot can stamp on. In this manner, even handicapped person with defect on his hand or ineffective on his fingers can handle the electric scooter easily.

### BACKGROUND OF THE INVENTION

1. Field of the Invention

The present invention relates to a mobility pedal structure for electric scooter, more particularly to a new mobility pedal structure for electric scooter by which even handicapped person with defect on his hand or ineffective on his fingers can handle the electric scooter easily.

2. Brief Description of the Prior Art

Some people suffer paralysis on their lower-half body caused by traffic accident, serious disease like stroke or damage, or incapability of standing and walking easily due to muscular dystrophy caused by chronically lie-up on bed without go down to walk about, or slow in action with their legs incapable of walking freely due to physiological degeneration happened in elderly people. Usually, those handicapped person get assistance from sticks or wheelchairs to move when they want to take long-distance travel. As these equipments are manually operated, not only a lot of strength is consumed but also moving speed is very slow. It is this reason that industries have developed electric scooter, which transforms electricity into power, so as to help handicapped people to move.

With respect to the speed control structure of electric scooter, a Taiwanese Patent Gazette No. M356504 has proposed a structure entitled “Shake-proof Structure for Operating Lever of Electric scooter”, in which a connecting piece is provided on the handle bar, a mobility sensing portion having a rotary shaft for triggering mobility and speed being disposed on the connecting piece, the rotary shaft being combined with an operating lever for controlling the moving speed of electric scooter, wherein an abutment annular pad is provided on the operating lever where the rotary shaft is combined, the abutment annular pad abutting against the connecting piece and protecting the outside of the rotary shaft. In this manner, no matter whether the operating lever is pushed to abut right-hand side or left-hand side handling portion, the operating lever can conduct stable handling without shaking so as not to transmit inaccurate message to the rotary shaft. In addition, the abutment annular pad can protect the outside of the rotary shaft such that the rotary shaft is not deformed by the clogging of dirty stuff so as to achieve accurate transmission of steering speed.

Although the above “Shake-proof Structure for Operating Lever of Electric Scooter” can achieve anticipated effect of accurate transmission of steering speed, it is found in practical application that the operating lever is assembled on the handle bar. User has to operate the operating lever by his hand, i.e., handicapped person with defect on his hand or ineffective on his fingers cannot handle the electric scooter easily. Therefore, change or modification should be adopted so as to conduct speed control at the other place. In this case, the usage of electric scooter is very inconvenient so that there are still space of improvement in its total, implementation and usage.

In view of the above shortcomings in prior arts, the inventor of the present invention hereby proposes a mobility pedal structure of electric scooter according to research and improvement conducted on prior art, on the basis of his proficient experience and knowledge in R&D and manufacturing in relevant field, with a purpose to achieve better practical value of the invention.

### SUMMARY OF INVENTION

This invention relates to a mobility pedal structure of electric scooter, in which a spindle is rotationally supported on two side plates of a base; a speed control device being connected to one side of the spindle and a recovery spring element being inserted onto outside of the spindle; a connection block being fixed on the spindle, on which a connection rod having an advance control portion and a retreat control portion being coupled; then, the base being disposed at a position where user's foot can stamp on. In this manner, even handicapped person with defect on his hand or ineffective on his fingers can handle the electric scooter easily. It can increase more practical value in the integral embodiment and usage thereof.

### BRIEF DESCRIPTION OF THE DRAWINGS

FIG. 1 is a perspective schematic view showing the mobility pedal structure of the present invention.

FIG. 2 is a schematic view showing the mobility pedal structure of the present invention in assembled state.

FIG. 3 is a schematic view showing the mobility pedal structure of the present invention in advancing state.

FIG. 4 is a schematic view showing the mobility pedal structure of the present invention in retreating state.

### DETAILED DESCRIPTION OF PREFERRED EMBODIMENTS

The objects, the technical contents and the expected effectiveness of the present invention will become more apparent from the detailed description of the preferred embodiment in conjunction with the accompanying drawings.

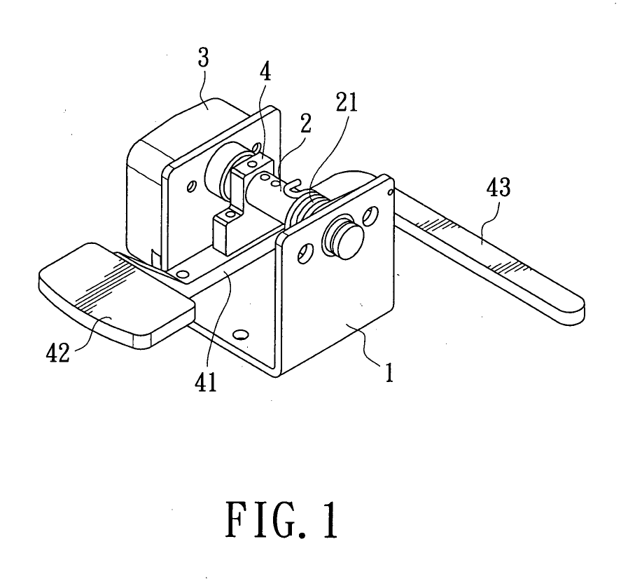

FIG. 1 is a perspective schematic view showing the mobility pedal structure of electric scooter of the present invention. Firstly referring to FIG. 1, a spindle (2) is rotationally supported on two side plates of a base (1). A speed control device (3) is connected to one side of the spindle (2) and a recovery spring element (21) is inserted onto outside of the spindle (2). A connection block (4) is further fixed on the spindle (2), on which a connection rod (41) having an advance control portion (42) and a retreat control portion (43) is coupled.

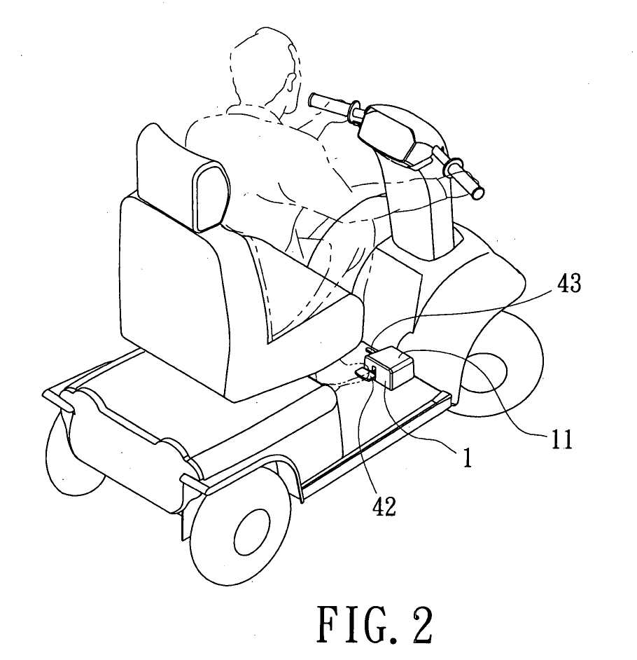

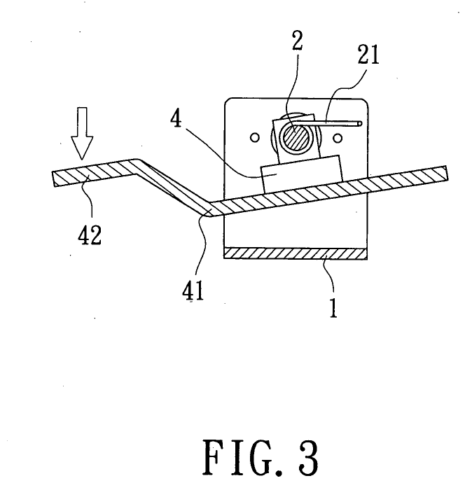

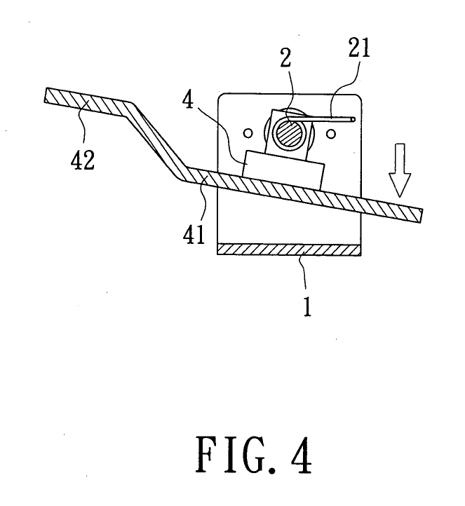

Then referring to FIG. 2 showing an assembled state of the present invention, after a casing (11) is covered on the base (1), the base (1) can be disposed at a pedal for feet of the electric scooter or a position where user's foot can stamp on. When the electric scooter is to be advanced, user stamps on the advance control portion (42) which then moves the spindle (2) to rotate through the connection rod (41) and the connection block (4). The advancing speed of the electric scooter is controlled by the speed control device (3) coupled to the spindle (2), as shown in FIG. 3. When the electric scooter is to be retreated, user stamps on the retreat control portion (43) to retreat the electric scooter and the retreating speed of the electric scooter is also controlled by the speed control device (3) coupled to the spindle (2), as shown in FIG. 4. If user releases the stamping on the advance control portion (42) and the retreat control portion (43), the spindle (2) together with the connection block (4) and the connection rod (41) will return back to its original position by the action of the recovery spring element (21) such that the advance control portion (42) and the retreat control portion (43) recover to their unstamped positions, too.

Based on the description of the structure and the preferred embodiment, the present invention has the following advantages when comparing with conventional art. The mobility pedal structure of electric scooter of the present invention has a spindle is rotationally supported on two side plates of a base. A speed control device is connected to one side of the spindle and a recovery spring element is inserted onto outside of the spindle. A connection block is fixed on the spindle, on which a connection rod having an advance control portion and a retreat control portion is coupled. Then, the base is disposed at a position where user's foot can stamp on. In this manner, even handicapped person with defect on his hand or ineffective on his fingers can handle the electric scooter easily. Hence, it can increase more practical convenience in the integral embodiment and usage thereof.

The abovementioned embodiment or drawings are not intended to restrict the product aspect, structure or usage mode of the present invention. Various modifications and variations can be made without departing from the spirit and scope of the present invention, as set forth in the appended claims.

Summing up above, the embodiment of the present invention can reach anticipated effect, and the specific configurations disclosed herein have yet not found in the prior art of the same category of product, even has not been opened to the public before application.

What is claimed is:

1. A mobility pedal structure of electric scooter, wherein a spindle is rotationally supported on two side plates of a base; a speed control device being connected to one side of the spindle and a recovery spring element being inserted onto outside of the spindle; a connection block being fixed on the spindle, on which a connection rod having an advance control portion and a retreat control portion being coupled; then, the base being disposed at a position where user's feet can stamp on.

2. The mobility pedal structure of electric scooter as claimed in claim 1, wherein a casing is covered on said base.

3. The mobility pedal structure of electric scooter as claimed in claim 1, wherein said base is disposed on the pedal for feet of the electric scooter.
